(19) United States
(12) Patent Application Publication
(10) Pub. No.: US 2021/0326996 A1
(43) Pub. Date: Oct. 21, 2021

(54) SYSTEM AND METHOD FOR INSURING PROPERTY OWNERS

(71) Applicant: Charles D. Childers, Miami, FL (US)

(72) Inventor: Charles D. Childers, Miami, FL (US)

(21) Appl. No.: 17/307,381

(22) Filed: May 4, 2021

Related U.S. Application Data
(63) Continuation-in-part of application No. 15/942,657, filed on Apr. 2, 2018.
Application No. 15/942,657 is a continuation-in-part of application No. 14/469,660, filed on Aug. 27, 2014, now abandoned.
(60) Provisional application No. 61/993,670, filed on May 15, 2014.

(51) Int. Cl. G06Q 40/08; G06Q 30/00

(52) U.S. Cl. CPC G06Q 40/08; G06Q 30/018

(57) ABSTRACT

A system and method for insuring property owners in defending non-compliance claims filed in federal or state courts or administratively under the Americans with Disabilities Act (ADA) including a database containing compliance standards of the ADA. A user interface is operatively connected to the database inputs initial evaluation data, of the insured property, obtained by insurer's personnel. A processor operatively connected to the database is structured for comparative processing of the initial evaluation data with the compliant standards of the ADA and is structured to determine initial compliance violations thereof indicated by the initial evaluation data. A report is generated by and comprises the initial compliance violations and remediation recommendations. Secondary evaluation data indicative of remaining compliance violations of the insured property, subsequent to remediation of the initial compliance violations, is determined and is at least initially excluded from a generated insurance policy.

### CLAIM OF PRIORITY

The present application is a continuation-in-part application of previously filed, now pending application having Ser. No. 15/942,657 filed on Apr. 2, 2018, which in is a continuation-in-part application of previously filed, now abandoned application having Ser. No. 14/469,660, filed on Aug. 27, 2014, which is based on a claim of priority is made under 35 U.S.C. Section 119(e) to a provisional patent application that is currently pending in the U.S. Patent and Trademark Office, namely, that having Ser. No. 61/993,670 and a filing date of May 15, 2014, and which is incorporated herein by reference.

### BACKGROUND OF THE INVENTION

### Field of the Invention

This invention is directed to a system and attendant method for insuring and indemnifying property owners in the defense of non-compliance claims under the Americans with Disabilities Act (ADA). An insurance policy or product is offered, either as a separate policy or part of an umbrella policy. The policy will cover the property owner for all attorney and legal fees related to the defense of a claim filed in federal and state courts under the ADA including, but not limited to, Titles II, III, and IV.

### Description of the Related Art

The Americans with Disabilities Act (ADA) is a law that was enacted by the U.S. Congress in 1990. The ADA is a wide-ranging civil rights law that prohibits, under certain circumstances, discrimination based on disability. Disability as defined by the ADA includes a physical or mental impairment that substantially limits a major life activity. The determination of whether any particular condition is considered a disability is made on a case-by-case basis. Certain conditions are excluded as disabilities, such as current subset abuse and visual impairment that is correctable by prescription lenses.

In the year 2008, the ADA Amendments Act was signed into law. This Amendments Act was intended to give broader protections for disabled workers and reconsider previous court rulings that Congress deemed too restrictive. This Amendments Act of 2008 includes a list of “major life activities”.

Title II prohibits disability discrimination by all public entities at the local and state level. Public entities must comply with Title II regulations by the US Department of Justice. These regulations cover access to all programs and services offered by an entity. Access includes physical access described in the ADA Standards for accessible design and programmatic access that might be obstructed by discriminatory policies or procedures of the entity in question. In addition, Title II applies to public transportation provided by public entities through regulations by the U.S. Department of Transportation. This section requires the provision of para-transit services by public entities that provide fixed route services. Title II also applies to all state and local public housing, housing assistance and housing referrals.

Title III sets standards for construction of accessible public facilities. Under Title III, no individual may be discriminated against based on disability with regards to the full and equal enjoyment of the goods, services, facilities or accommodations in any place of “public accommodation” by any person who owns, leases or operates a place of “public accommodation”. Public accommodations include most places of lodging, recreation, transportation, education and dining along with stores, care providers in places of public display. In addition, under Title III all “new construction” after the effective date of the ADA must be fully compliant with the ADA guidelines.

Title III also has application to existing facilities. One of the definitions of “discrimination” under Title III is a failure to remove architectural barriers in existing facilities. This means that even facilities that have not been modified or altered in any way after the ADA was passed, still have obligations. The applied standard is whether “removing barriers” is readily achievable or easily accomplish without much difficulty or expense. The statutory definition of “readily achievable” calls for a balancing test between the cost of the proposed remediation and the wherewithal of the business/or owners of the business. As a result, there are exceptions to this title including, but not limited to private clubs and religious organizations. However, historical places or properties must still comply with the provisions of Title III to the extent feasible, without destroying the historic significance of a feature of the historically designated facility.

Title IV of the ADA amended the landmark Communications Act of 1934 primarily by adding a section requiring that all telecommunications companies in the United States take steps to ensure functionally equivalent services for consumers with disabilities. Notably, this includes those who are deaf or hard of hearing and those with speech impairments.

Indemnity insurance compensates the beneficiaries of the policies for their actual economic losses, up to the limiting amount of the corresponding insurance policy. Recovery generally requires the insured to prove the amount of its loss. The coverage is limited to the amount of the provable loss even if the face amount of the policy is higher. By way of example, this contrasts to life insurance, where the amount of the beneficiary's economic loss is irrelevant. The death of the person whose life is insured, for reasons not excluded from the policy, obligate the insurer to pay the entire policy amount to the beneficiary. Coverage is usually continued for as long as the policyholder is associated with the insured facility, product, service, etc. Canceling of a policy would, in effect, make it as if the insured never had coverage. A break in coverage could result in what is called a “gap in coverage”, which is the loss of all prior protection.

Accordingly, due to the nature of the ADA in terms of requiring compliance and the rapid increase of lawsuits being filed against property and business owners, there is a need in this area for a system and/or method of insuring property owners in defending non-compliance claims under the ADA. Such a proposed system and method should be operative to determine any initial compliance violations of the insured property as well as remediation recommendations sufficient to bring the property owner in compliance with the ADA. Protection of a possible insurer would further include a review of the insured property after any remediation of the initial compliance violations to determine the possible existence of secondary compliance violations. A list of such secondary compliance violations could include, but not necessarily be limited to, any of the initial compliance violations which were not corrected to comply with the appropriate standards of the various titles of the ADA. Further, a proposed system and method for insuring property owners could specifically include monetary indemnification for a legal defense of claims against the property owner because of alleged non-compliance with the ADA.

### SUMMARY OF THE INVENTION

The present invention is directed to a system and method in the form of an insurance product such as an individual policy or a part of an umbrella policy, offered to property owners that are obligated under the Americans with Disabilities Act (ADA) to make their properties compliant. In more specific terms, the system and attendant method is directed to insuring property owners in defending non-compliance claims under the ADA. As a result, an insurance policy or product, as generally set forth above, comprises a monetary indemnification of the property owner for a legal defense of claims against the property owner under the ADA filed, for example, in federal and state courts. Further, the system and method of the present invention are directed to insuring property owners which are alleged to be in non-compliance specifically with, but not limited to, Titles I, II and III.

Accordingly, the system and method of the present invention are directed to insuring property owners in defending non-compliance claims under the ADA and includes processor facilities including a database having dedicated storage facilities structured for containment of the compliant standards of the ADA. In addition, a user interface is operatively connected to the database and structured for input of initial evaluation data associated with a subject insured property. A processor is operatively connected to the database and is structured for comparative processing of the initial evaluation data with the compliant standards of applicable one or more Titles the ADA. A data output is connected to the processor and is cooperatively structured to generate a report comprising any initial compliance violations existing at or on the subject insured property. In addition, secondary evaluation data is obtained and is indicative of any remaining compliance violations of the subject insured property after an attempted or actual remediation of the initial compliance violations of the insured property. As a result, an insurance policy comprising monetary indemnification for a legal defense of claims against the property owner, corresponding to the insured property, under the ADA is generated preferably, but not exclusively, by the aforementioned data output.

In addition, the generated insurance policy may include an exclusion provision including a list of exclusions of any secondary compliance violations or remaining compliance violations which still exist at or on the insured property after the remediation of the initial compliance violations, as set forth above. However, such exclusions from the generated insurance policy may eventually be removed upon remediation by or as a result of the acts of the property owner.

Additional components of the system and method of the present invention include the monetary indemnification, which includes a monetary amount of attorney fees and other legal fees or costs charged the property owner in defense of non-compliance with the ADA. Further, the above noted generated report further comprises a citation of ADA standards, associated with specific Titles, violated by each of the initial compliance violations of the of initial evaluation data. The report may further include pictorial representations corresponding to at least the initial compliance violations of the subject property. As such the pictorial representations may be in the form of photographs, colored or black and white line drawings, renderings or any other appropriate pictorial representation which adequately and accurately presents evidence of at least the initial compliance violations. Further, the generated report may also include standards of the ADA applied for the remediation recommendations of the insured property in violation.

The data output associated with the processor used to implement the system and method for insuring property owners in defense of the ADA may also comprise a display screen structured for the electronic display of the various sections or components of the report including, but not limited to the aforementioned pictorial representations. As such, the data output may also include a printer structured to generate a hard copy of the report in addition to the electronic display.

In order to provide interactive cooperation between the property owner being insured and an insurer, the system and method of the present invention further includes interactive negotiation between the property owner and the insurer. Such interactive negotiation may include the determination of a time period which is appropriate to allow the property owner to remediate and/or correct at least the initial compliance violations. Such remediation by the property owner hopefully corresponds to the remediation recommendations provided to the property owner by the generated report. As also indicated, failure to make remediation of the initial compliance violations, or any part thereof, will be determined and/or detected by a review of the insured property resulting in the determination of secondary compliance violations.

In some embodiments of the invention, one or more rules-based engines are disclosed. The rules-based engine includes a rules builder configured to create and store rules derived from one or more accessibility parameters under the standards of the ADA. The rules-based system, executed by one or more microprocessors, can perform a number of tasks automatically and in parallel, such as: generating a checklist specific to the property being evaluated, performing cost analysis for remediation work, establishing the barriers to be remediated under the “readily achievable” standard, and performing time analysis for remediation priority and dates of completion, among others.

In addition to the above, another method for the underwriting of an indemnity policy for defending any non-compliant violations of the ADA would include a preliminary or initial ADA compliance inspection of the subject insured property. The preliminary ADA compliance inspection would be conducted by personnel having appropriate expertise regarding the content of and compliance with the ADA and most probably, but not necessarily exclusively, representing the insurer. As a result, initial evaluation data would be collected which would include, at least in part, the initial compliance violations of the insured property as well as ADA standards violated thereby. Upon determination, the initial compliance data would be entered via the user interface into the database associated with the aforementioned processor. Thereafter a report would be generated, via the output data which would be indicative of the initial compliance violations and be presented to the property owner and appropriate personnel of the insurer.

Included in the generated report would be the initial compliance violations existing at the insured property as well as remediation recommendations for each of the initial compliance violations. To more completely protect the property owner a time period would be determined which would be sufficient and appropriate for the property owner to accomplish remediation and/or correction of the initial compliance violations. As a result, such remediation's would hopefully and preferably bring the subject insured property into compliance with the appropriate standards of the ADA. Subsequent to the time period and accomplished remediation of the initial compliance violations, such as by the property owner or representatives of the property owner, secondary evaluation data would be determined or collected. This may also be accomplished by a visitation and observation of the insured property by personnel expertly knowledgeable of the ADA, as well as the specific Titles relating to the insured property.

If in fact the initial compliance violations were not corrected or adequately remediated the secondary visitation would result in the determination and documentation of secondary compliance violations. The existence of any secondary compliance violations would result in a secondary or subsequent exclusion provision including a list of exclusions from the generated indemnification policy for the property owner in defending allegations of the ADA. However, at least one feature of the system and method of the present invention would include the removing of such exclusions of the secondary compliance violations once the corresponding violations have in fact been corrected or remediated.

Accordingly, a final generated and or amended insurance policy would comprise an amount of monetary indemnification for a legal defense of claims against the property owner under the ADA.

These and other objects, features and advantages of the present invention will become clearer when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a schematic representation in block diagram form of the structural and operative facilities associated with the implementation of the system and method of the presented invention.

FIG. 2 is a schematic representation in block diagram form representative of the various procedures associated with the implementation of the system and method of the present invention. Like reference numerals refer to like parts throughout the several views of the drawings.

### DETAILED DESCRIPTION OF THE PREFERRED EMBODIMENT

As represented in the accompanying Figures, the present invention is directed to a system and attendant method for insuring and indemnifying property owners in the defense of non-compliance claims filed in federal or state courts or administratively under the Americans with Disabilities Act (ADA). An insurance policy or product is offered, either as a separate policy or part of an umbrella policy. The policy will cover the property owner for all attorney and legal fees related to the defense of a claim filed under the ADA specifically including, but not limited to, Titles II, III and IV.

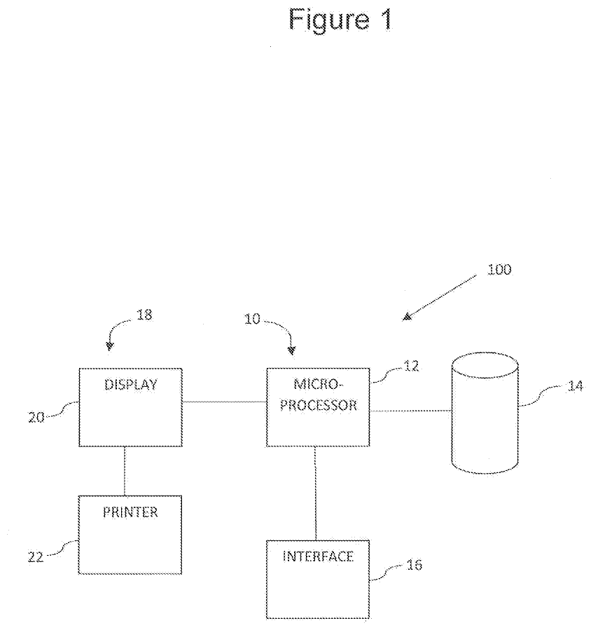

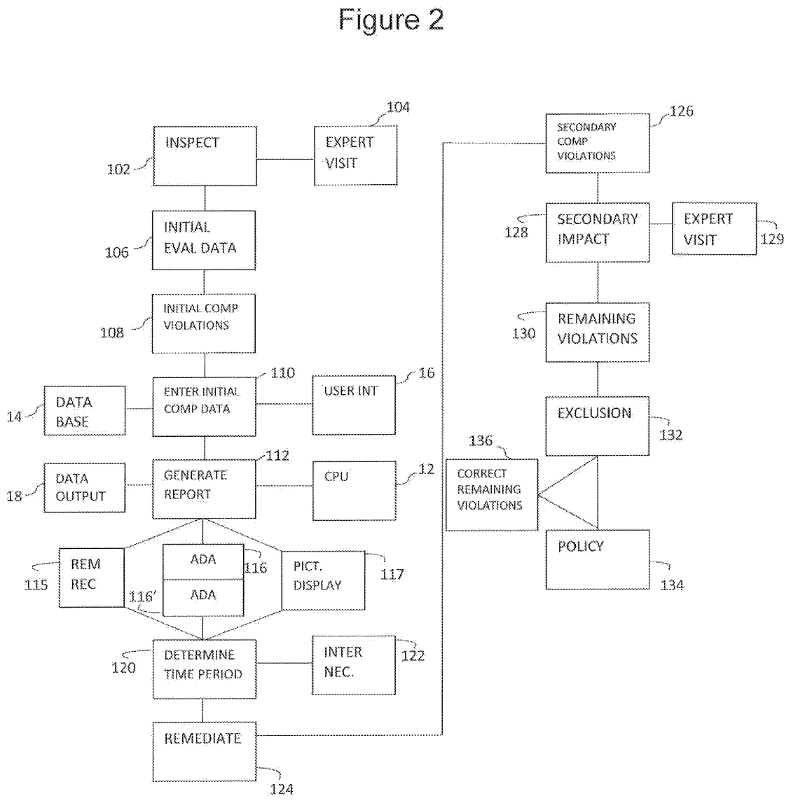

More specifically, the system and method of the present invention are schematically represented as 100 in both FIGS. 1 and 2, which may be implemented by processor facilities 10 including a central processor 12 operatively connected to a database 14 having dedicated storage facilities structured for containment of the compliant standards the Titles of the ADA. In addition, a user interface 16 is operatively connected to the database 14 and central processor 12 and is structured for input of “initial evaluation data” 106, and other data, information, etc. associated with a subject insured property. As indicated, the central processor 12 is operatively connected to the database 14 and is structured for comparative processing of the initial evaluation data 106 with the compliant standards of the applicable one or more Titles the ADA. A data output generally indicated as 18 is connected to the processor 12 and is cooperatively structured there with to generate a report 112 comprising any “initial compliance violations” 108 existing at or on the subject insured property. As such, the data output 18 may include an electronic display 20, such as a display screen associated with a conventional computer, as well as a printer 22 structured to generate hard copies of the report and its contents.

In addition, and as explained in greater detail hereinafter, “secondary evaluation data” 126 is obtained and is indicative of any remaining compliance violations of the subject insured property subsequent to an attempted or actual remediation 124 of the initial compliance violations 108 of the insured property. In more specific terms, the secondary evaluation data 126 contains any violations which the property owner and/or the representative thereof failed to correct and or bring into compliance with the ADA. As a result, an insurance policy or product, as set forth above will be generated and comprise a guarantee of monetary indemnification for a legal defense of claims against the property owner, corresponding to the insured property, under the ADA is generated preferably, but not exclusively, by the aforementioned data output 18. The generation of the report 112 on which the insurance policy or insurance product is based may be concurrently generated on the electronic display 20 as well as the printer 22, the latter being produced in the form of a hard copy. As practically applied, the generated report 112 will be available to the property owner as well as personnel of the insurer and other appropriate entities as deemed necessary in order to assure compliance of the property owner and the subject insured property with the ADA.

However, the resultant insurance policy based on a personal inspection of the insured property, as at 104 and 129, as set forth in greater detail hereinafter, may include exclusions 132 of any secondary or remaining compliance violations 126, which still exist at or on the insured property subsequent to the remediation 124 of the initial compliance violations 108, as set forth above. It is to be noted that such exclusions 132 from the insurance policy may eventually be removed and covered by the final or amended insurance policy when and/or if the secondary or remaining compliance violations 126, 130, 136 are corrected and brought into compliance with the appropriate standards and Titles of the ADA.

Additional components of the system and method 100 of the present invention may define the “monetary indemnification” as including a monetary amount of attorney fees and other legal fees or costs for which the property owner is liable in defense of non-compliance with the ADA. Further, as described in greater detail in FIG. 2 the above noted generated report 112 may also include a citation of ADA standards 116 associated with specific Titles corresponding to each of the initial compliance violations 108 of the of initial evaluation data 106. The report 112 may further include pictorial representations 117 produced on both the electronic display 20 and/or the printer 22 which appropriately and accurately visually represent each of the initial compliance violations 108 of the subject insured property. As such the pictorial representations 117 produced on either the electronic display screen 20 and/or in hard copy form on the printer 22 may be in the form of photographs, colored or black and white line drawings, renderings or any other appropriate pictorial representation which adequately and accurately presents visual evidence of each of the initial compliance violations 108. Further, the generated report 112 may also include standards of the ADA 116′ applied for the remediation recommendations of the insured property in violation.

In one embodiment, computer-readable instructions are stored on at least one database 14 and, when executed, are operable to access a rules-based engine to analyze parameters and data to determine insurance coverage. Parameters such as ADA compliance standards, specific policy provisions per insured customer, and facts about the potentially insurable situation are stored in the one or more databases 14. In one embodiment, a predetermined process is configured to be executed by the at least one processor 10 to automatically evaluate the parameters, provisions, and facts to generate a checklist for the property being evaluated. In one embodiment, the same or similar rules-based engine evaluates parameters, provisions, and facts to establish what the barriers are to be remediated under one or more rules, such as the “readily achievable” standard, for example. For these and other rules-based analysis, the parameters, provisions, and/or facts can be updated as needed, and the analyses can be repeated as needed to include all currently relevant information and data. In one embodiment, the invention discloses a rules-based engine operable to perform a cost analysis of remediation work that is required under a given insurance provision. The system can direct microprocessor 12 to evaluate data, such as the RSMeans Construction Cost Indexes, in order to determine the industry standard costs involved. These indexes are a means to compare costs from city to city, over time, and to localize the national average construction costs, and can be stored in at least one system database 14. In this or another embodiment, the rules-based engine can perform a time analysis for remediation work and dates of completion. In this and other embodiments, all the data, checklist, and reports are stored in databases 14.

One or more databases 14 can store, among other things, ADA standards such as the “readily achievable” standard. In one embodiment, the rules-based engine determines achievement of this standard based on factors stored in database 14 such as nature and cost of remediation; financial resources of the facility involved; number of facility employees; effect on facility expenses, resources, and operations; financial resources of the covered entity; business size of the covered entity; number of employees of the covered entity; facilities and operations of the covered entity; and administrative and fiscal relationship between the facility and the covered entity. Further criteria evaluated by the system in determining a “readily achievable” standard are the difficulty and expense required to make a facility accessible. For example, some easily accomplished accommodations include installing handles, markings, and other hardware; rearranging furniture and partitions; widening passageways; and creating designated parking spaces, to name just a few.

The ADA mandates that all public accommodations are required to be accessible to the disabled community and be in conformance with certain standards. Public accommodations include such various structures as hotels, shopping malls, banks, restaurants, office buildings, movie theaters, and sports arenas, to name a few. The specialized software disclosed herein includes rules-based algorithms that generate a customized checklist based on particular elements of the property or facility. In one embodiment, a hotel checklist includes elements of a swimming pool, guestrooms, and a fitness area. These data, checklists, reports, and more can be stored in databases 14. In another embodiment, a bank checklist includes the elements of private viewing rooms and bank teller counters.

In order to provide interactive cooperation between the property owner being insured and an insurer, one or more additional preferred embodiments of the system and method 100 of the present invention further includes interactive negotiation 122 between the property owner and the insurer, as further described hereinafter with reference to FIG. 2. Such interactive negotiation 122 may include the determination of a time period 120 which is appropriate to allow the property owner to remediate and/or correct, as at 124, at least the initial compliance violations 108. Such remediation 124 by the property owner hopefully corresponds to the remediation recommendations 116 provided to the property owner by the generated report. As also indicated, failure to make remediation of the initial compliance violations 108, or any part thereof, will be determined and/or detected by an on-site review 128 by expert personnel of the insured property resulting in the determination of secondary or remaining compliance violations 126, as set forth above.

Accordingly, with primary reference to FIG. 2, the system and method 100 for the underwriting of an indemnity policy for defending any non-compliant violations of the ADA may include a preliminary or initial ADA compliance inspection 102 of the subject insured property. The preliminary ADA compliance inspection 102 would be conducted by personnel 104 having appropriate expertise regarding the content of and compliance with the ADA and most probably, but not necessarily exclusively, representing the insurer. As a result, initial evaluation data 106 would be collected. The initial evaluation data 106 includes, at least in part, the initial compliance violations 108 of the insured property as well as ADA standards violated thereby. Upon determination, the initial compliance data 106, as well as the initial compliance violations 108 would be entered as at 110, via the user interface 16, into the database 14 associated with the aforementioned processor facilities 10 including the central processor 12. Thereafter a report 112 would be generated, via the data output 18 including the electronic display screen 20 and/or the printer 22. The report 112 would be indicative of the initial compliance violations 108 and be presented to at least the property owner and appropriate personnel of the insurer.

As also schematically represented in FIG. 2, the generated report 112 would include the initial evaluation data 106 comprising the initial compliance violations 108 existing at the insured property. The generated report 112 would also include remediation recommendations 115 for each of the initial compliance violations 108; a citation of ADA standards 116 violated by each of the initial compliance violations 108 of the initial evaluation data 106 and citations of the ADA standards 116′ for the remediation recommendations 115. In addition, the report 112 further comprises the aforementioned pictorial representations and/or photographs 117 corresponding to at least the initial compliance violations 108 of the subject insured property.

In order to more completely protect the property owner and facilitate the repair, reconstruction, and remediation of the initial compliance violations 108, a time period would be determined, as at 120. The time period 120 would preferably be accomplished through interactive negotiation 122 between the property owner and representatives of the insurer. During the negotiated time period 120 the property owner would accomplish remediation 124 and/or correction of the initial compliance violations 106 as indicated. Such remediation 124 would hopefully and preferably bring the subject insured property into compliance with the appropriate standards and Titles of the ADA.

Subsequent to the determined and/or negotiated time period 120 and the accomplished remediation 124 of the initial compliance violations 106, “secondary evaluation data” 126 would be determined or collected. This may preferably be accomplished by a visitation and observation 128 of the insured property by personnel, as at 129, expertly knowledgeable of the ADA, as well as the specific Titles relating to the insured property.

If in fact the initial compliance violations 108 were not corrected or adequately remediated the secondary visitation 128 would result in the determination and documentation of secondary or remaining compliance violations 130. The existence of any secondary compliance violations 130 would result in an exclusion, as at 132, of these remaining or secondary compliance violations 130 from the indemnification insurance policy or product 134 granted the property owner in defending allegations of noncompliance with the ADA. However, at least one embodiment of the system and method 100 of the present invention would include the removing of such exclusions 132 of the non-corrected secondary or remaining compliance violations 128 once the corresponding violations have in fact been corrected or remediated, as at 136. Accordingly, a final generated and or amended insurance policy 134 would comprise the monetary indemnification for a legal defense of claims against the property owner under the ADA.

At These computer-executable program instructions may be loaded onto a general-purpose computer, a special purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the disclosure may provide for a computer program product, comprising a computer usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special purpose, hardware-based computer systems that perform the specified functions, elements or steps, or combinations of special purpose hardware and computer instructions.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents, to include the computer-executable instructions created and implemented to effectuate the computer-enabled embodiments.

What is claimed is:

1. A system for generating an Americans with Disabilities Act (ADA) insurance policy for a given property, said system comprising:
processor facilities including software comprising computer readable instructions,
ADA compliance standards accessible via said processor facilities,
an initial evaluation input associated with the given property,
at least one comparative evaluation of said initial evaluation input with said ADA compliance standards being determinative of initial compliance violations,
at least one other comparative evaluation of said initial evaluation input, said ADA compliance standards and a remediation of said initial compliance violations being determinative of secondary compliance violations, and
a customized mandatory indemnification provision, included in the ADA insurance policy, comprising a monetary indemnification amount.

2. The system as recited in claim 1 wherein said processor facilities are configured to generate a list of secondary compliance violations upon expiration of at least one remediation time period; said one remediation time period set for said remediation of said initial compliance violations.

3. The system as recited in claim 1 further comprising establishment of an exclusion list including said secondary compliance violations.

4. The system as recited in claim 3 wherein said exclusion list is at least partially defined by at least one pictorial representation of said secondary compliance violations.

5. The system as recited in claim 3 wherein said computer readable instructions are configured via said processor facilities to define said exclusion list based at least in part on said secondary compliance violations.

6. The system as recited in claim 5 further comprising an updated content of said exclusion list defined by updated ADA compliant standards, said remediation's of said initial compliance violations and new compliance violations.

7. The system as recited in claim number 6 further comprising at least one remediation time period determinative of said remediation of said initial compliance violations via said processor facilities; said computer readable instructions configured to determine said updated secondary compliance violations, based at least in part on an expiration of said at least one remediation time period.

8. The system as recited in claim 1 wherein said computer executable instructions are configured to calculate said monetary indemnification amount.

9. The system as recited in claim 1 comprising determination of a secondary exclusion list at least partially defined by a comparative evaluation of said initial compliance violations and said secondary compliance violations.

10. The system as recited in claim 1 further comprising remediation recommendations input at least partially determinative of said remediation of said initial compliance violations.

11. The system as recited in claim 1 further comprising incorporating the ADA insurance policy in an umbrella policy.

12. A method of generating an Americans with Disabilities Act (ADA) insurance policy for a given property, said method comprising:
accessing stored ADA compliance standards;
determining initial evaluation data associated with the given property;
determining initial compliance violations via a comparative evaluation of the initial evaluation data and the ADA compliance standards;
determining secondary compliance violations via a comparative evaluation of the initial evaluation data, the ADA compliant standards and a remediation of the initial compliance violations;
establishing a remediation time period for remediation of the initial compliance violations and determining a list of secondary compliance violations, upon expiration of the remediation time period;
establishing a customized monetary indemnification provision of the subject property and at least the secondary compliance violations; and
establishing an exclusion list based at least in part on the secondary compliance violations.

13. The method as recited in claim 12 further comprising establishing a secondary exclusion list comprising the initial compliance violations and the secondary compliance violations.

14. The method as recited in claim 12 comprising updating the exclusion list according to at least one of updated ADA compliant standards, remediations of the initial compliance violations and new compliance violations.

15. The method as recited in claim 12 wherein the exclusion list comprises at least one pictorial representation of the secondary compliance violations.

16. The method as recited in claim 12 comprising defining the augmented list of secondary compliance violations via input from secondary evaluation data of the given property.

17. The method as recited in claim 12 comprising utilizing remediation recommendations for the establishing of the customized monetary indemnification provision.

18. The method as recited in claim 12 wherein the customized mandatory indemnification provision is included in the ADA insurance policy and comprises a monetary indemnification amount related to contemplated legal fees.

19. The method as recited in claim 12 further comprising outputting the ADA insurance policy digitally via at least one of a display screen.

20. The method as recited in claim 12 further comprising outputting the ADA insurance policy in the form of a hard copy, via a printer.
